(19) United States
(12) Patent Application Publication
(10) Pub. No.: US 2022/0279827 A1
(43) Pub. Date: Sep. 8, 2022

(54) OLEOGEL COMPOSITIONS AND FLAVOR DELIVERY SYSTEMS FOR PLANT-BASED MEAT ANALOGUES

(71) Applicant: Paragon Flavors, Inc., Princeton, NJ (US)

(72) Inventors: Matthew SILLICK, Montgomery, NJ (US); Christopher Mark GREGSON, Princeton, NJ (US)

(73) Assignee: Paragon Flavors, Inc., Princeton, NJ (US)

(21) Appl. No.: 17/685,380

(22) Filed: Mar. 3, 2022

Related U.S. Application Data
(60) Provisional application No. 63/247,925, filed on Sep. 24, 2021.
(60) Provisional application No. 63/156,084, filed on Mar. 3, 2021.

(51) Int. Cl. A23L 29/206; A23L 19/00; A23L 33/15; A23L 33/115

(52) U.S. Cl. CPC A23L 29/206; A23L 19/09; A23L 33/15; A23L 33/115

(57) ABSTRACT

An oleogel composition and a method to create the oleogel composition are described. The method includes: combining a gelator with an oil, co-melting the gelator and the vegetable oil at a temperature to form a melt, dispersing at least one immiscible inclusion in the melt to form a mixture, cooling the mixture to create a solidified oleogel, and incorporating the solidified oleogel into a meat analogue mixture.

### CROSS-REFERENCE TO RELATED APPLICATIONS SECTION

This Application is a U.S. Non-Provisional patent application that claims priority to U.S. Provisional Patent Application Ser. No. 63/247,925 filed on Sep. 24, 2021 and U.S. Provisional Patent Application Ser. 63/156,084 filed on Mar. 3, 2021, the entire contents of which are hereby incorporated by reference in their entirety.

### FIELD OF THE EMBODIMENTS

The field of the invention and its embodiments relate to oleogel compositions and methods to create such. The field of the invention and its embodiments also relate to flavor delivery systems for plant-based meat analogues.

### BACKGROUND OF THE EMBODIMENTS

Animal fats play an important role in the development of flavor. Fat replicas provide important elements of flavor, juiciness, and visual cues to plant-based meat analogues. The Impossible™ plant-based burger patty uses animal fat replicas based on mixtures of coconut oil and sunflower oil. The burgers are sold in a raw/refrigerated format and use a number of triggers, such as a change in color of the muscle replica and melting of the fat replica, to provide consumers with a cooking experience that mimics that of cooking a beef burger. The animal fat replica must be sufficiently solid at refrigerated temperatures, such that it does not leak from formed patties and imparts the appearance white particles of fat. Also, the animal fat replica must melt appropriately upon cooking to release a significant portion of the liquid oil to the pan or gill, yet also retain some amount of liquid oil within the patty.

Coconut or palm oil is used in plant-based burgers due to its high melt point and vegetable origin. However, it is high in saturated fat, which is broadly considered detrimental to health. Additionally, its cultivation is linked to deforestation, habitat loss, greenhouse gas emissions, and the threatening of critically endangered species, such as the orangutan and Sumatran tiger.

In contrast, rice bran oil is an abundant by-product from rice polishing. Rice is the second-highest produced grain worldwide. Moreover, rice bran oil can be formulated into a solid oleogel by combination with an appropriate gelator. However, such oleogels are only partially crystalline and can be less opaque as compared to solidified hydrogenated vegetable oils or vegetable oils that are rich in saturated fats (such as palm oils).

As consumers are striving to eat and live a healthier lifestyle, oleogels have emerged as a promising potential means of replacing hardstock fats in food systems. However, despite the recent exponential growth in this field, the use of oleogels is still in the early stages of development and faces numerous challenges, such as: restrictions on gelator concentrations in food products. Thus, improved oleogel compositions and methods to create such are needed. Moreover, flavor delivery systems for plant-based meat analogues are also needed.

### REVIEW OF RELATED TECHNOLOGY

U.S. Pat. No. 10,798,958 B2 describes ground meat replicas and plant-based products that mimic ground meat, including the fibrousness, heterogeneity in texture, beefy flavor, and red-to-brown color transition during cooking of ground meat.

U.S. Published Patent Application No. 2008/0254199 A1 provides a process for producing a colored structured protein product with protein fibers that are substantially aligned and the resultant product. Specifically, the plant protein is combined with a colorant and extruded, forming a colored structured protein product with protein fibers that are substantially aligned and the resultant product.

WO 2013/010042 A1 provides methods and compositions related to plant based meat substitutes which have properties similar to meat.

U.S. Published Patent Application No. 2006/0204644 A1 relates to a process for making a vegetable base meat analogue, which may be used in a variety of vegetarian food products, such as burger patties and sausages. The process of the present invention involves sequentially blending methyl cellulose into a water/ice mix to form a cream, then blending in a modified gluten, a vegetable protein product having high solubility in water and capable of forming a gel with mild heat treatment, an oil to make an emulsion base, and a modified food starch and flavoring ingredients to form a flavored emulsion base. The flavored emulsion base may be stuffed into casings, and then cooked. The flavored emulsion base, once cooked, is a vegetable base meat analogue and has a high resemblance to processed meat products having improved handling properties. The addition of the flavored emulsion base and the vegetable base meat analogue in vegetarian food products improves the texture, mouthfeel, and juiciness of the resulting products.

U.S. Published Patent Application No. 2002/0034570 A1 relates to cheese flavoring containing both volatile and non-volatile components which comprise constituents which contribute to the taste sensation “cheese”.

WO 2013/010037 A1 describes methods and compositions for the production of cheese replicas. Generally the cheese replicas are produced by inducing the enzymatic curdling of non-dairy milks.

U.S. Published Patent Application No. 2010/0310738 A1 describes a method of processing that provides improved water retention and enhanced coloring and flavor, while preserving the meat and preventing bacterial contamination. In an exemplary embodiment, the method includes: (a) providing a body of meat at a first temperature; (b) contacting the body of meat of step (a), in at least one treating vessel, with a brine solution at a second temperature, wherein the second temperature is greater than the first temperature, and wherein the brine solution comprises a vinegar-derived food additive and/or a reddening agent, wherein the reddening agent comprises nitrite; (c) agitating the body of meat at the second temperature for a time sufficient to distribute the solution throughout the body of meat; (d) cooling the body of meat in at least one cooling vessel to a third temperature, wherein the third temperature is less than the second temperature; (e) agitating the body of meat at the third temperature; (f) contacting the body of meat of step (e) with the brine solution at the third temperature and agitating the body of meat at the third temperature until the brine solution is substantially absorbed by the body of meat; and (g) recovering the body of meat in a dry state at the third temperature. In one embodiment, the aforementioned brine solution comprises a vinegar-variety food additive, such as a vinegar-derived acetate composition. In another embodiment, the reddening agent comprises nitrate derived from plant material comprising nitrate.

Various plant-based meat compositions and methods of creating such plant-based meat compositions exist. However, their means of operation are substantially different from the present disclosure, as the other inventions fail to solve all the problems taught by the present disclosure.

### SUMMARY OF THE EMBODIMENTS

The present invention and its embodiments relate to oleogel compositions and methods to create such. Moreover, the present invention and its embodiments relate to flavor delivery systems for plant-based meat analogues.

A first embodiment of the present invention describes a method to create an oleogel. The method includes: combining a gelator with an oil, co-melting the gelator and the oil at a temperature to form a melt, dispersing at least one inclusion in the melt to form a mixture, and cooling the mixture to create a solidified oleogel. In some examples, the gelator is a rice bran wax, a jojoba wax, a sunflower wax, a Rhus succedanea fruit wax, a pongamia seed wax, or a grape seed wax. In other examples, the oil is a rice bran oil, a sunflower oil, an olive oil, a grape seed oil, an avocado oil, an almond oil, or a soy oil. The temperature is between approximately 50° C. to approximately 120° C.

The method may also include incorporating the solidified oleogel into a meat analogue mixture. In other examples, the method may include engaging the solidified oleogel in a particle formation process and incorporating the solidified oleogel into a meat analogue mixture. The particle formation process includes prilling, extrusion granulation, and/or milling. The particles are suspended in oil to create a pumpable oleogel prill-in-oil dispersion prior to incorporation into a meat analogue mixture.

Moreover, in some examples, the gelator and the oil are from a same botanical source. In other examples, the at least one inclusion is an immiscible flavor precursor. The immiscible flavor precursor may be in a crystalline form, and may be a vitamin, a mineral, a reducing sugar, a starch such as rice or quinoa starch, a salt, and/or an amino acid. The vitamin may include vitamin B1, niacin, vitamin B6, vitamin B2, or vitamin B12.

Further, in some examples, the at least one inclusion is in a form of immiscible liquid droplets and may comprise an aqueous amino acid solution. In other examples, the liquid droplets comprise a surfactant. Additionally, the at least one inclusion is a natural flavor or a immiscible spray-dried flavor. In other examples, the at least one inclusion is micronized or emulsified to enhance an opacifying effect.

A second embodiment of the present invention describes a plant-based burger comprising approximately 5% to approximately 40% of an oleogel as a visible fat replica.

A third embodiment of the present invention describes an oleogel composition that includes: approximately 1% to approximately 50% of one or more oil inclusions, approximately 50% to approximately 99% of a non-hydrogenated vegetable oil, and approximately 1% to approximately 20% of a gelator. The one or more oil inclusions impart flavor or flavor precursors.

A fourth embodiment of the present invention describes a system. The system includes: a first oleogel composition having a first melting point and a second oleogel composition having a second melting point. Each of the first oleogel composition and the second oleogel composition comprise: one or more oil inclusions that impart flavor or flavor precursors, a non-hydrogenated vegetable oil, and a gelator. The first melting point differs from the second melting point to release the flavor or the flavor precursors at differing time periods during cooking.

A fifth embodiment of the present invention describes a method. The method includes numerous process steps, such as: mixing a rice bran wax with a rice bran oil to create a mixture, heating the mixture to a temperature to create a melt, combining the melt with crystalline glucose or crystalline thiamine hydrochloride, and homogenizing the melt using a mixer. The method may also include dripping an aliquot of the melt onto the tray and solidifying the melt into oleogel-glucose dispersion prills or oleogel-thiamine dispersion prills. In other examples, the oleogel-glucose dispersion prills and the oleogel-thiamine dispersion prills are more opaque and whiter than oleogel prills.

In some examples, the oleogel prills comprise a lower opacity compared to the oleogel-glucose dispersion prills and the oleogel-thiamine dispersion prills. Moreover, in other examples, a separation of the oleogel-glucose dispersion prills and the oleogel-thiamine dispersion prills and a reduction of sugar inclusions generates a Maillard flavoring upon melting.

In general, the present invention succeeds in conferring the following benefits and objectives.

It is an objective of the present invention to improve upon food oleogels to enhance their opacity.

It is an objective of the present invention to provide a system for delivering flavors and/or flavor precursors.

It is an objective of the present invention to improve upon food oleogels to enhance their stability against coarsening of the vegetable wax network.

### BRIEF DESCRIPTION OF THE DRAWINGS

FIG. 1 depicts a block diagram of a method to create an oleogel, according to at least some embodiments disclosed herein.

FIG. 2 depicts images of oleogel particles of Example 1 and Example 2, according to at least some embodiments disclosed herein.

FIG. 3 depicts images of oleogel-glucose dispersion prills, oleogel-thiamine dispersion prills, and oleogel prills that do not contain inclusions of Example 3, according to at least some embodiments disclosed herein.

FIG. 4 depicts images of prills of a rice bran oleogel without inclusions, prills of the rice bran oleogel with glucose inclusions, and prills of the rice bran oleogel with thiamine inclusions of Example 3, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

### Food Oleogels

As defined herein, an “oleogel” is a semisolid system in which continuous liquid phases are physically immobilized by self-assembled networks of gelators. See, M. A. Rogers, et al., “Edible oleogel in molecular gastronomy,” Int. J. Gastron. Food Sci., 2014, 2, 22-31, the entire contents of which are hereby incorporated by reference in their entirety. Many food products, including meat products, dairy, spreads, confectionaries, and pastries, can be formulated with oleogels. For example, one group formulated cakes with methylcellulose (MC) oleogels and documented similar hardness and chewiness to those made with shortening. In another study, emulsion-based shellac oleogels were shown to crystallize emulsion phases and water-oil interfaces, stabilizing the emulsion for four months. See, A. R. Patel, et al., “Edible oleogels based on water soluble food polymers: preparation, characterization and potential application,” Food Funct., 2014, 5, 2833-41; and A. R. Patel, et al., “Edible applications of shellac oleogels: spreads, chocolate paste and cakes,” Food Funct., 2014, 5, 645-52, the entire contents of which are hereby incorporated by reference in their entirety.

In addition, another study showed that cookies made with wax oleogels exhibited oil binding capacity above 93% with a minimum oil loss for thirty days. See, G. Fayaz, et al., “Potential application of pomegranate seed oil oleogels based on monoglycerides, beeswax and propolis wax as partial substitutes of palm oil in functional chocolate spread,” LWT, 2017, 86, 523-9, the entire contents of which are hereby incorporated by reference in their entirety. Another group produced a heat resistant chocolate made with an ethylcellulose (EC) oleogel that resisted melting up to 86° C. See, T. A. Stortz, et al., “Heat resistant chocolate,” Trends Food Sci. Technol., 2011, 22, 201-14, the entire contents of which are hereby incorporated by reference in their entirety. These examples showcase the use of oleogels in food applications. See, Clifford Park, et al., “A Critical Review of the Last 10 Years of Oleogels in Food,” Front. Sustain. Food Syst., 2020, Vol. 4, Article 139, Pages 1-8, the entire contents of which are hereby incorporated by reference in their entirety.

Not only are the nutritional functionalities of the oleogels a key consideration, but one must assess the textual properties of the oleogels and the stability of the oleogels for food applications. Certain oleogel-based food products have been shown to contain healthier nutritional profiles as compared to those made with conventional hardstock fats. For example, one study incorporated rice bran wax oleogels in cream cheese products, showing that replacing milkfat led to a 120% increase in unsaturated fat content and about a 90% reduction in saturated fat content. See, H. L. Bemer, et al., “Vegetable organogels incorporation in cream cheese products,” Food Res. Int., 2016, 85, 67-75, the entire contents of which are hereby incorporated by reference in their entirety. Another group formulated Bologna-type sausages with oleogels, replacing pork back fats, which resulted in a 6% reduction in total saturated fat content and an up to 21.15% increase in oleic acid levels. See, S. L. da Silva, et al., “Fat replacement by oleogel rich in oleic acid and its impact on the technological, nutritional, oxidative, and sensory properties of Bologna-type sausages,” Meat Sci., 2019 149, 141-8, the entire contents of which are hereby incorporated by reference in their entirety. A similar result was observed in meat patties made with hydroxypropyl methylcellulose (HPMC) oleogels. See, I. Oh, et al., “Feasibility of hydroxypropyl methylcellulose oleogel as an animal fat replacer for meat patties,” Food Res. Int., 2019, 122, 566-72, the entire contents of which are hereby incorporated by reference in their entirety.

Though these results show oleogels' capability for enhancing food nutrition, digestibility of these products requires further examination. Oleogels having high melting points (e.g., between 60° C.-135° C.) may impact the meltability of lipid networks in human body temperature. Oleogels with low meltability may retard the release of the lipid matrix, hence possibly influencing the overall metabolism of oleogel food.

In addition, another objective for using oleogels is in the mimicking of textural functionality of trans and hardstock fats. One study found that frankfurters made with EC oleogels showed similar hardness and chewiness values as compared to beef fat controls. See, A. K. Zetzl, et al., “Mechanical properties of ethylcellulose oleogels and their potential for saturated fat reduction in frankfurters,” Food Funct., 2012, 3, 327-37, the entire contents of which are hereby incorporated by reference in their entirety. Other groups have found that oleogels made with monoglycerides show large plate-like shapes of crystals, while fibrous oleogel microstructures are obtained from phytosterols. See, A. Lopez-Martinez, et al., “Comparing the crystallization and rheological behavior of organogels developed by pure and commercial monoglycerides in vegetable oil,” Food Res. Int., 2014 64, 946-57; and H. Sawalha, et al., “The influence of the type of oil phase on the self-assembly process of γ oryzanol+β-sitosterol tubules in organogel systems,” Eur. J. Lipid Sci. Tech., 2013, 115, 295-300, the entire contents of which are hereby incorporated by reference in their entirety. Further, oleogels made with different waxes exhibit considerably different matrices. See, A. R. Patel, et al., “Rheological profiling of organogels prepared at critical gelling concentrations of natural waxes in a triacylglycerol solvent,” J. Agric. Food Chem., 2015, 63, 4862-9; and E. Yilmaz, et al., “Comparative analysis of olive oil organogels containing beeswax and sunflower wax with breakfast margarine,” J. Food Sci., 2014, 79, E1732-8, the entire contents of which are hereby incorporated by reference in their entirety. As such, oleogels structured with various gelator types generate different microstructural properties that affect physical properties of the oleogels, as well as the associated food products.

Moreover, as defined herein, “oil binding capacity” refers to how strongly oil is bound in a given network. Food products with low oil binding capacity release oil and undergo oil migration, which negatively affects their textural and sensory attributes. Several studies have found a linear relationship between mechanical strength of gels and oil binding capacity, suggesting that oleogels could minimize oil loss when designed with greater mechanical strength and tightly arranged networks. See, G. Fayaz, et al., “Potential application of pomegranate seed oil oleogels based on monoglycerides, beeswax and propolis wax as partial substitutes of palm oil in functional chocolate spread,” LWT, 2017, 86, 523-9; and Z. Meng, et al., “Effects of thickening agents on the formation and properties of edible oleogels based on hydroxypropyl methyl cellulose,” Food Chem., 2018, 246, 137-149, the entire contents of which are hereby incorporated by reference in their entirety. As such, the application of oleogels to food products is promising, but requires further study and examination.

### Invention

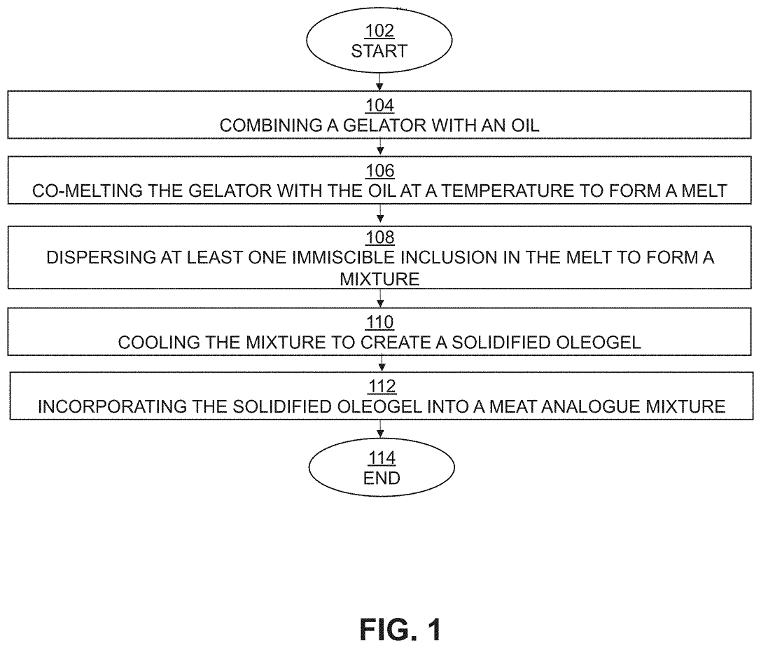

The present invention improves upon food oleogels to enhance their opacity and provide a system for delivering flavors and/or flavor precursors. FIG. 1 depicts a block diagram of a method to create an oleogel, according to at least some embodiments disclosed herein.

As shown in FIG. 1, the method comprises numerous process steps, and begins at a process step 102. The process step 102 is followed by a process step 104 that includes combining a gelator with an oil. In some examples, the gelator and the oil are from a same botanical source. For example, the gelator may be a rice bran wax and the oil may be a rice bran oil. In other examples, a crude botanical extract can contain both the oil and the gelator. For example, crude unwinterized rice bran extract can contain sufficient amounts of both oil and wax. In some examples, the oil and wax can be produced using “green” extraction technologies, such as those reviewed by Garofalo et al. Biomass Cony. Bioref. 11, 569-587 (2021). Green extraction avoids the uses of harmful solvents, such as hexane, and instead uses non-conventional solvents, such as water, ethanol, isopropanol, ethyl acetate, D-limonene and/or supercritical carbon dioxide, which may be assisted using microwaves, ultrasound, enzymes, or pressure. Suitable gelators include a rice bran wax, a jojoba wax, a sunflower wax, a Rhus succedanea fruit wax, a berry fruit wax (Rhus verniciflua) a pongamia seed wax, a grape seed wax, or combinations thereof. Other suitable gelators include ethyl cellulose and stearic acid. Suitable oils include vegetable oils, such as rice bran oil, fractionated rice bran oil, pongamia oil, olive oil, sunflower oil, peanut oil, avocado oil, and almond oil. A unifying feature of these oils is that they derive from botanical sources and contain less that 40% saturated fat.

A process step 106 follows the process step 104 and includes co-melting the gelator and the oil at a temperature in a range between approximately 50° C. to approximately 120° C. to form a melt. A process step 108 follows the process step 106 and includes dispersing at least one immiscible inclusion in the melt to form a mixture. The at least one immiscible inclusion is necessary, as it imparts opacity to the oleogel and creates a flavor delivery system.

In a first example, the at least one immiscible inclusion is a flavor precursor. The flavor precursor may be in a crystalline form, and may be: a vitamin, a mineral, a salt, and/or an amino acid, among others. The vitamin may be: vitamin B1, niacin, vitamin B6, vitamin B2, and/or vitamin B12, among others. In other examples, the at least one immiscible inclusion may include zinc gluconate, and/or iron gluconate.

The immiscible inclusion may also be a spray dried flavor powder. Without wishing to be bound by theory, the flavor powder or other immiscible inclusion may further benefit the oleogel system by providing nucleation sites for rapid crystallization of the gelator. In other examples, the immiscible inclusion consisting of a spray dried flavor powder protects the flavor by effectively constituting a double encapsulation. Flavor compounds with intermediate log P values are first spray dried within a carbohydrate carrier and the resulting flavor powder entrapped within the oleogel. The intermediate log P flavor compounds which otherwise would be soluble in oil and/or bind to protein are isolated within the carbohydrate carrier. The carbohydrate carrier, which otherwise would be soluble in water, is isolated within the semi-solid oleogel.

In another example, the at least one immiscible inclusion may be in a form of liquid droplets. In some examples, the liquid droplets comprise an aqueous amino acid solution. In another example, the liquid droplets comprise a surfactant. In a further example, the at least one immiscible inclusion is a natural flavor or a spray-dried flavor. In an additional example, the at least one immiscible inclusion is micronized or emulsified to enhance an opacifying effect.

A process step 110 follows the process step 108 and includes cooling the mixture to create a solidified oleogel. An optional process step follows the process step 110 and includes engaging the solidified oleogel in a particle formation process. Such process may include: prilling, extrusion granulation, drum flaking and/or milling, among others. Such processes may also include swept surface crystallization and block formation such as is typically used for margarine manufacturing. A process step 112 follows the process step 110 and includes incorporating the solidified oleogel into a meat analogue mixture. A process step 114 follows the process step 112 and ends the method to create the oleogel of FIG. 1.

It should be appreciated that the oleogel described herein prevents the release of the flavor or flavor precursor during refrigerated storage and controls their release upon cooking. The oleogel also prevents oil from leaking from the refrigerated patties.

In an embodiment, a plant-based burger is described that comprises approximately 5% to approximately 40% of the oleogel (formed by the method of FIG. 1) as a visible fat replica. The oleogel is present in sufficient quantities so as to constitute a nutritionally significant proportion of the food. As the oleogel is nutritionally significant, and not merely an incidental additive, it provides food formulations a capacity for achieving lower saturated fat levels than would be achieved using visible fat replicas derived from palm or coconut fat. In other embodiments, the oleogel is present small amounts and delivers relatively concentrated levels of flavor. In such cases, the primary role of the oleogel is as a flavor delivery system providing relatively little nutritional benefit.

In some embodiments, the melting point of the oleogel is above a temperature of about 40° C., which means that it melts later during cooking as compared to tropical fats, such as palm and coconut oils. Without wishing to be bound by theory, this facet may allow oleogels that contain flavors to release those flavors later in the cooking process. As flavors, particularly top-note flavors are volatile and lost during cooking, the oleogel may enable better flavor retention during cooking.

In another embodiment, the oleogel composition (formed by the method of FIG. 1) includes: approximately 1% to approximately 50% of one or more oil immiscible inclusions, approximately 50% to approximately 99% of a non-hydrogenated and non-chemically transesterified vegetable oil, and approximately 1% to approximately 20% of a gelator.

In a further embodiment, a system includes a first oleogel composition and a second oleogel composition (each formed by the method of FIG. 1). The first oleogel composition is associated with a first melting point and the second oleogel composition is associated with a second melting point. Each of the first oleogel composition and the second oleogel composition comprise: one or more oil immiscible inclusions that impart flavor or flavor precursors, a non-hydrogenated vegetable oil, and a gelator. Moreover, the first melting point differs from the second melting point to release the flavor or the flavor precursors at differing time periods during cooking.

Thus, as explained, plant-based meat analogues are fast growing and significant components of the food industry. This invention can help address missing components, as it is know that the fat profile of most plants is not ideal for recapitulating the properties of animal-based fats.

### EXAMPLES

### Example 1: Oleogels with 6% Wax

A measure of 3 grams of rice bran wax was combined with 47 grams of grape seed oil and heated to 90° C. to create a melt. A small aliquot of the melt was dripped onto a steel tray and solidified into oleogel particles.

Separately, 4.8 grams of thiamine hydrochloride and 2.0 grams of gum acacia were brought to 20 grams with water, dissolved and warmed to 70° C. Then, 5 grams of the thiamine/acacia solution was added to 50 grams of the hot oil/wax melt and homogenized with hand help high shear mixer. The resulting emulsion was dripped onto the steel tray to form solid oleogel/emulsion particles. The oleogel-emulsion particles were visibly more-opaque than the oleogel particles. Both types had a soft solid consistency and held their shape without leaking oil.

### Example 2: Oleogels with 10% Wax

A measure of 5 grams of rice bran wax was combined with 45 grams of grape seed oil and heated to 90° C. to create a melt. A small aliquot of the melt was dripped onto a steel tray and solidified into oleogel particles.

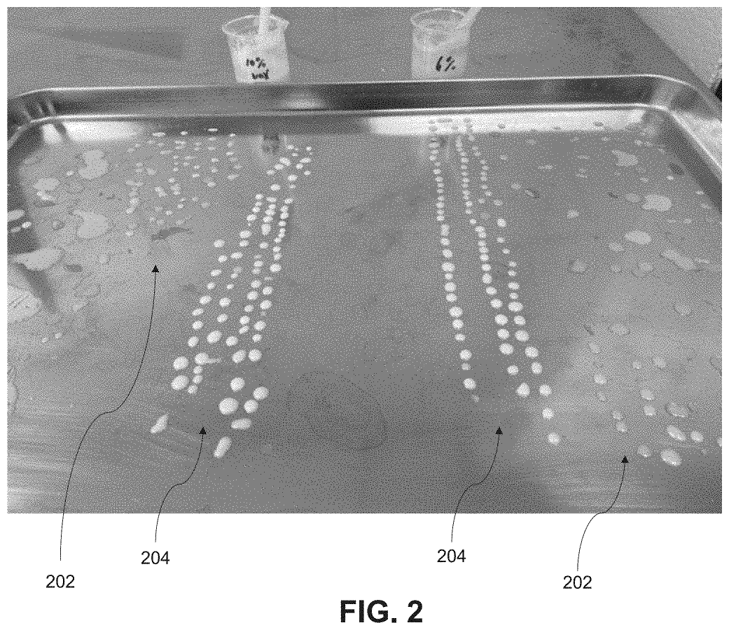

Oleogel emulsions were created using the thiamine gum acacia solutions. These were dripped onto the steel tray to solidify into particles. Again, the oleogel-emulsion particles were visibly more-opaque than the oleogel particles. Again, the oleogel emulsion particles held their shape without leaking oil. Compared to the 6% wax oleogel-emulsion particles of Example 1, the 10% wax oleogel-emulsion particles of Example 2 had more firm or hard consistency. FIG. 2 depicts an image of particles of Example 1 and Example 2, according to at least some embodiments disclosed herein. Oleogel-emulsion particles with inclusions 204 are depicted in the center of the image of FIG. 2 and are more opaque than oleogel particles without inclusions 202, located at a left and a right side of the image of FIG. 2. Moreover, the oleogel particles of Example 1 and Example 2 may be stored on the steel tray at 15° C. for 2 weeks with the steel tray being oriented in a vertical position. The particles were observed to have held their shape without moving and without a leakage of oil or water.

### Example 3: Oleogels with 10% Wax and Crystalline Inclusions

A measure of 7 grams of rice bran wax was combined with 63 grams of rice bran oil and heated to 90° C. to create a melt. A small aliquot of the melt was dripped onto a steel tray and solidified into oleogel prills. As defined herein, a “prill” is a small aggregate or globule of a material, most often a dry sphere, formed from a melted liquid. Then, 18 grams of the rice bran wax/rice bran oil melt was combined with 2 grams of crystalline glucose and homogenized using a high shear mixer. A small aliquot was dripped onto a steel tray and solidified into oleogel-glucose dispersion prills.

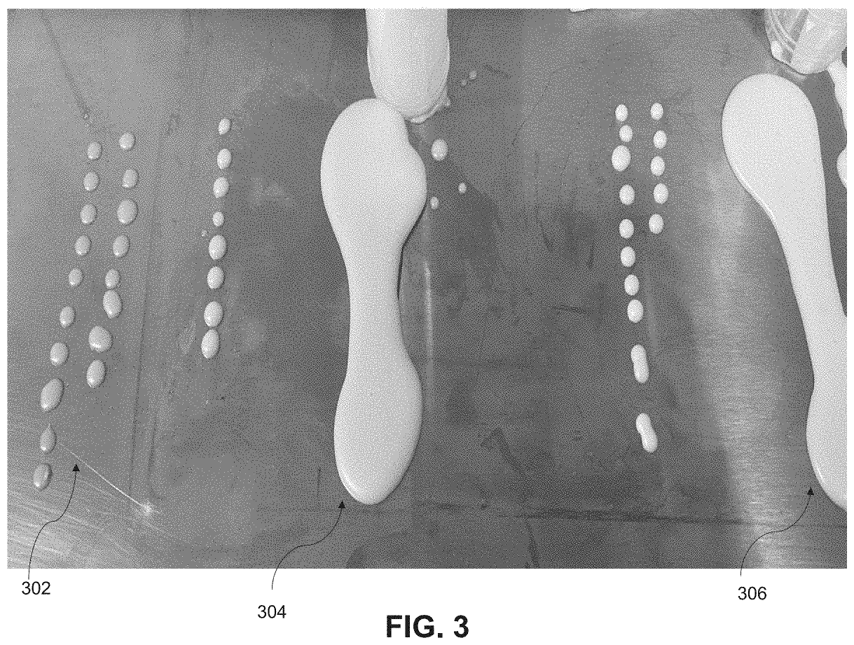

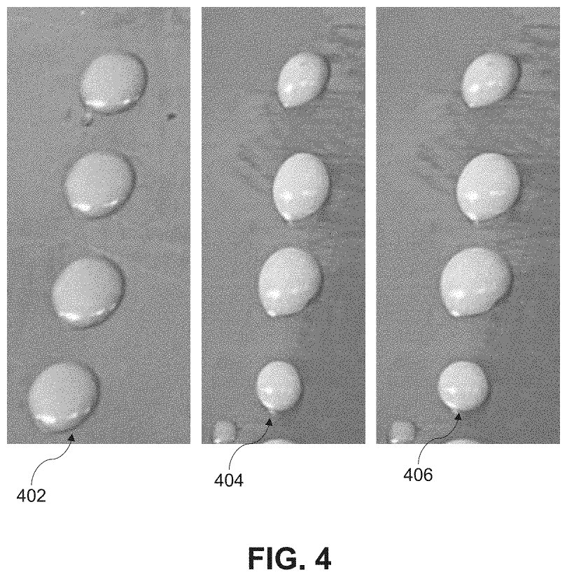

Separately, 18 grams of the rice bran wax/rice bran oil melt was combined with 2 grams of crystalline thiamine hydrochloride and homogenized using a high shear mixer. A small aliquot was dripped onto a steel tray and solidified into oleogel-thiamine dispersion prills. As shown in FIG. 3, the oleogel-glucose dispersion prills 304 and oleogel-thiamine dispersion prills 306 were both whiter and more opaque compared to the oleogel prills that did not contain inclusions 302. As shown in FIG. 4, prills of the rice bran oleogel without inclusions 402 have a lower opacity as compared to prills of rice bran oleogels with glucose 404 and thiamine inclusions 406. It should be appreciated that a separation of the oleogel-glucose dispersion prills and the oleogel-thiamine dispersion prills and a reduction of sugar inclusions generates a Maillard flavoring upon melting. As defined herein, a “Maillard reaction” is a chemical reaction between amino acids and reducing sugars that gives browned food its distinctive flavor. Seared steaks, fried dumplings, cookies and other kinds of biscuits, breads, toasted marshmallows, and many other foods undergo this reaction.

### Example 4: Plant Based Meat Analogue with Oleogel System

In examples, 76 grams of water was combined with 26 grams of textured soy protein (Solae Response® 4410, Dupont biosciences). Separately 4 grams of isolated soy protein (Solae Supro® 500E, Dupont Biosciences) was hydrated with 16 grams of water. Separately, 3 grams of methylcellulose (Methocel SG A16M, Dupont) was mixed with 35 grams of water. All of these mixtures were allowed to rest for 45 minutes and then combined together. A measure of 2 grams of salt and 2 grams of red beet juice powder were added and thoroughly mixed. This mixture was then passed through the meat grinder attachment of a Kitchenaid® mixer using a die plate with 5 mm holes to create a ground muscle analogue.

Next, 80 grams of a ground muscle analogue was combined with 10 grams of the glucose oleogel dispersion and 10 grams of the thiamine oleogel dispersion of Example 3. The preparation was coarsely mixed to create a meat analogue with regions of pink muscle replica and white fat replica in an approximation of 80:20 ground beef. The mixture was formed into about 114 gram patties.

### Example 5: Oleogels

In a first example, a measure of 5 grams of rice bran wax (Koster Keunen) was combined with 45 grams of pongamia oil and heated to approximately 90° C. to create a melt. A beaker of the melt was stored at approximately 4° C. to form an oleogel.

In a second example, a measure of 5 grams of candelilla wax was combined with 45 grams of avocado oil and heated to approximately 90° C. to create a melt. A beaker of the melt was stored at approximately 4° C. to form an oleogel.

In a third example, a measure of 5 grams of Rhus succedanea fruit wax was combined with 45 grams of grapeseed oil and heated to approximately 90° C. to create a melt. A beaker of the melt was stored at approximately 4° C. to form an oleogel.

In a fourth example, a measure of 5 grams of crude rice bran wax attained from the Thai Edible Oil Company was combined with 44 grams of rice bran oil and heated to approximately 90° C. to create a melt. One gram of cardamom flavor from Bakto Flavors LLC was added to the melt. A aliquot of the melt was dripped onto a steel tray and solidified into oleogel prills approximately 2 to 10 mm in size. A beaker of the melt was stored at approximately 4° C. to form an oleogel.

In a fifth example, a measure of 7.1 grams of crude rice bran wax attained from the Thai Edible Oil Company was combined with 43.1 grams of rice bran oil and heated to approximately 90° C. to create a melt. A beaker of the melt was stored at approximately 4° C. to form an oleogel.

In a sixth example, a measure of 7.1 grams of crude rice bran wax attained from the Thai Edible Oil Company was combined with 2.5 grams of limonene flavoring and 40.4 grams of rice bran oil and heated to approximately 90° C. to create a melt. A beaker of the melt was stored at approximately 4° C. to form an oleogel.

In a seventh example, a measure of 7.1 grams of crude rice bran wax attained from the Thai Edible Oil Company was combined with 15 grams of Beef Crackling Type Nat liquid flavoring attained from Flavor and Fragrance Specialties Inc. and 27.9 grams of rice bran oil and heated to approximately 90° C. to create a melt. A beaker of the melt was stored at approximately 4° C. to form an oleogel.

In an eighth example, a measure of 7.1 grams of crude rice bran wax attained from the Thai Edible Oil Company was combined with 2.5 grams of Pork Type Nat spray dried flavoring attained from Flavor and Fragrance Specialties Inc. and 40.4 grams of rice bran oil and heated to approximately 90° C. to create a melt. A beaker of the melt was stored at approximately 4° C. to form an oleogel.

In a ninth example, a measure of about 5.0 grams of rice bran wax obtained from Koster Keunen was combined with about 10 grams of Beef Grill Type natural spray dried flavoring obtained from Flavor and Fragrance Specialties Inc. and about 45 grams of Riceland rice bran oil and was then heated to about 90° C. to create a melt/flavor powder suspension. Then, about 65 grams of the melt/flavor powder suspend was poured into a chilled aluminum mold to rapid cool the mixture and to form a rectangular-shaped oleogel block. The oleogel was then removed from the block and tempered to about 4° C.

In a tenth example, a fractionated rice bran oil was attained from the King Rice Oil Group and was cooled to a temperature of 4° C. The rice bran oil shortening is described by the manufacture as rice bran oil having less than 40% saturated fat. Hereafter, we will refer to this material as “rice bran stearin.” Rice bran stearin is available from various rice refineries, as described by Shi et al. JAOCS Volume 93, Issue 6 2016 p 869-877.

In an eleventh example, a measure of about 7.0 grams of crude rice bran wax obtained from the Thai Edible Oil Company was combined with about 10 grams of Beef Grill Type natural spray dried flavoring obtained from Flavor and Fragrance Specialties Inc. and about 43 grams of rice bran stearin (King Rice Oil Group) and was then heated to about 90° C. to create a melt/flavor powder suspension. Then, about 65 grams of the melt/flavor powder suspend was poured into a chilled aluminum mold to rapid cool the mixture and to form a rectangular-shaped oleogel block. The oleogel was removed from the block and tempered to about 4° C.

The stiffness of the solidified oleogels in the previous examples was assessed using a Stable Micro Systems TA-HD textured analyzer with a 5 mm rod-shaped probe. Punch tests were performed by inserting the rod a depth of 5 mm into the oleogel at a speed of 5 mm/second. The peak force is reported in Table 1 below:

TABLE 1
Peak force of oleogel preparations on punch tests.

| | Punch | Punch | Punch | Punch |
|---|---|---|---|---|
| | test 1 | test 2 | test 3 | test 4 |
| | (grams) | (grams) | (grams) | (grams) |
| 10% Rhus succedanea | 236 | 222 | 216 | 227 |
| fruit wax, 90% grape seed oil | | | | |
| 10% Rice bran wax, 90% | 120 | 116 | 122 | 124 |
| pongamia oil | | | | |
| 10% crude rice bran wax, 90% | 190 | 224 | 164 | 150 |
| rice bran oil | | | | |
| 10% candillia wax, 90% | 565 | 514 | 645 | 671 |
| avocado oil | | | | |
| 15% rice bran wax, 85% rice | 334 | 370 | 381 | 367 |
| bran oil | | | | |
| 14% crude rice bran wax, 86% | 390 | 318 | 370 | 316 |
| rice bran oil | | | | |
| 14% crude rice bran wax, 5% | 309 | 283 | 320 | 300 |
| Limonene, 81% rice bran oil | | | | |
| 14% crude rice bran wax, 30% | 313 | 281 | 300 | 286 |
| beef crackling type flavor, | | | | |
| 66% rice bran oil | | | | |
| 14% crude rice bran wax, 5% | 337 | 274 | 332 | 253 |
| pork type spray dried flavor, | | | | |
| 81% rice bran oil | | | | |
| 8.3% rice bran wax, 16.6% | 958 | 748 | 1045 | |
| flavor, 75.1% rice bran oil | | | | |
| Rice bran stearin | 973 | 1210 | 1401 | |
| 11.6% crude rice bran wax, | 3962 | 3964 | 3437 | |
| 16.6% flavor, 71.8% rice bran | | | | |
| stearin | | | | |

### Example 6: Stable Dispersion of Oleogel Prills in Oil

The crude rice bran wax oleogel prills of Example 5 were collected from the steel tray and placed into a plastic container. To 10 grams of the soft solid prills, a measure of 10 grams of liquid rice bran oil was added to form a dispersion. The oleogel prills were observed to be stable while suspended in the oil, and did not dissolve or fuse together over a period of 2 weeks. The oleogel prill/oil dispersion can be handled as liquid by pouring, pumping or pipetting as long as the opening sizes within such liquid handling equipment is larger than the size of the oleogel prills. To further stabilize the oleogel prill dispersions against settling, air bubbles can be incorporated into the prills to enhance buoyancy. The oleogel prill/oil dispersion was coarsely mixed with a muscle analogue dough where the liquid oil blends in readily and the solid oleogel prills hold their original size and shape. Hence, this preparation method is a useful way to pre-granulate soft solid particles that can mimic particles within meat analogue products.

### Example 7: Rapidly Hardening Oleogel Prills with a Co-Gelator

The rate at which oleogel compositions solidify is important for certain manufacturing processes, such as drum flaking extrusion or pastillization. In all of these cases, the product needs to be discharged rapidly.

As a first example, a measure of about 4 grams of rice bran wax obtained from Koster Keunen was combined with about 46 grams of rice bran oil and was then heated to about 80° C. to create a melt. Next, about 10 grams of Beef Grill type natural flavor from Flavor and Fragrance Specialties was dispersed into the melt. An aliquot of the melt was dripped onto a steel tray and solidified into an oleogel prill approximately 2 to 10 mm in size. The cooling and solidification process of the oleogels was observed by periodically probing the prills with a spatula to determine if the prills could be mechanically removed from the tray without smearing the oleogel. The earliest time that the prills could be removed from the tray is reported in Table 2 below.

As a second example, a measure of about 4 grams of rice bran wax obtained from Koster Kuenen was combined with about 46 grams of rice bran stearin and was then heated to about 80° C. to create a melt. Next, about 10 grams of Beef Grill type natural flavor from Flavor and Fragrance Specialties was dispersed into the melt. An aliquot of the melt was dripped onto a steel tray and solidified into an oleogel prill approximately 2 to 10 mm in size. The earliest time that the prills could be removed from the tray with a spatula is reported in Table 2 below.

As a third example, a measure of about 50 grams of rice bran stearin was heated to about 80° C. to create a melt. An aliquot of the melt was dripped onto a steel tray and solidified into an oleogel prill approximately 2 to 10 mm in size. The earliest time that the prills could be removed from the tray with a spatula is reported in Table 2 below.

TABLE 2
Solidification time of oleogel preparations in prilling experiments

| Composition | Solidification time |
|---|---|
| Rice bran stearin | More than 60 minutes |
| 8.3% rice bran wax, 16.6% flavor, | Less than 2 minutes |
| 75.1% rice bran oil | |
| 8.3% rice bran wax, 16.6% flavor, | Less than 1 minute |
| 75.1% rice bran stearin | |

### Example 8: Flavoring System with Oleogels

A beef-type flavoring system was attained from Flavor and Fragrance Specialties. The system consists of two separate powdered flavors of vegan origin which in combination mimic the flavor of animal meat. The first powder consisted primarily of top-notes and intermediate log P flavor compounds (compounds with log P 1.5 to 4). The second powder contains hydrophilic flavors and Maillard reaction products with average log P<1.5. The first powder (Beef-type top-note powder) is light in color while the second powder contains all of the darker flavoring components.

A melt of about 8 grams Koster Keunen rice bran wax and about 92 grams of rice bran stearin were heated to about 85° C. to create a melt. Then, about 20 grams of the Beef-type top-note powder was dispersed into the melt. The melt was pipetted onto a steel tray to create oleogel prills and poured into a cold aluminum mold to create a block of oleogel. The block and the prills were light in color and appropriate for creating an animal fat mimetic.

Next, about 120 grams of the light colored oleogel prills were mixed into about 860 grams of a muscle analogue dough. Then, about 20 grams of the second darker flavor powder was also added to create a meat analogue with both dark flavorings and lightly colored fat particles. The mixture was formed into patties that were about 114 grams and about 3.5 inches in diameter and then cooked on an electric skillet at about 400° F. (or 204° C.). The oleogel particles were observed to melt later in the cooking process as compared to similar preparations with coconut fat particles. Thus, top note flavors avoided protein binding interactions during storage and are released by melting at a late stage during the cooking process.

### Example 9: Stability of Flavored Oleogels with Immiscible Inclusions

As a first example, a measure of about 4 grams of rice bran wax attained from Koster Kuenen was combined with about 46 grams of rice bran stearin and was then heated to about 80° C. to create a melt. Next, about 10 grams of Beef Grill type natural flavor from Flavor and Fragrance Specialties was dispersed into the melt. An aliquot of the melt was dripped onto a steel tray and solidified into an oleogel prill approximately 2 to 10 mm in size.

As a second example, a measure of about 4 grams of rice bran wax obtained from Koster Kuenen was combined with about 46 grams of rice bran oil (Riceland brand) and was then heated to about 80° C. to create a melt. Next, about 10 grams of Beef Grill type natural flavor from Flavor and Fragrance Specialties was dispersed into the melt. An aliquot of the melt was dripped onto a steel tray and solidified into an oleogel prill approximately 2 to 10 mm in size.

An encapsulated natural beef flavor powder was prepared as described in U.S. Published Patent Application No. 2021/0360955 A1, the contents of which are incorporated in their entirety, in order to create a flavor power using a natural wholegrain rice flour carrier. Briefly, a mixture of about 65 parts water and about 35 parts malted rice flour (Eckert Malting, Chico, Calif.) was prepared by first bringing the water to a temperature of about 70° C. under stirring conditions. Rice flour was added in about 2 equal increments separated by about 10 minutes in order to allow time for starch gelatinization and mashing while maintaining viscosity below 1000 centipoise. The mixture was processed using a high shear mixer (Silverson LMA-5) to break down residual particles and mashed for an additional 60 minutes at about 70° C. The preparation was cooled to a temperature of about 60° C., where the 100 parts of the flour/water suspension was combined with about 100 parts liquid natural beef type flavor (Bell Flavors) and mixed under high shear to form an emulsion. The emulsion was then transferred by peristaltic pump through a flexible hose to the atomizing nozzle of a lab spray dryer (Toption Lab Dryer with a centrifugal atomizing nozzle, inlet temperature of about 120° C. and outlet temperature of about 90° C.) and dried to create a beef flavor powder on a rice flour carrier. A measure of about 4 grams of rice bran wax obtained from Koster Kuenen was combined with about 44 grams of rice bran stearin and was then heated to about 80° C. to create a melt. Next, about 10 grams of the beef flavor/rice flour powder was dispersed into the melt. An aliquot of the melt was dripped onto a steel tray and solidified into an oleogel prill approximately 2 to 10 mm in size.

All of the prills of Example 9 were tasted and found to have pleasant beef-like flavors, rich mouthfeels and melted in the mouth even though vegetable wax oleogels are known to have melting points above 50° C. There was no obvious impression of waxiness.

A control sample was prepared by combining about 4 grams of rice bran wax obtained from Koster Kuenen with about 46 grams of rice bran oil (Riceland brand) and then heating to about 80° C. to create a melt. An aliquot of the melt was dripped onto a steel tray and solidified into an oleogel prill approximately 2 to 10 mm in size. The control prills had a neutral flavor and a smooth and slightly waxy mouth feel. All of the prills of Example 9 with water soluble flavor powder inclusions provided more of a sensation of meltaway compared to the control prills.

The prills were stored at room temperature conditions in closed containers for a time period of about six months. After the six month time period had expired, the control oleogel prills again presented a slightly waxy mouthfeel. In addition, the control prills were observed to be grainy, where “grainy” is being defined herein as coarse wax particles being detectable during consumption. The prills with water soluble flavor powder inclusions maintained their pleasant (non-grainy and non-waxy) mouthfeel even after six months.

### Example 10: Additional Oleogels with Unflavored Water-Soluble Inclusions

A readily soluble whole grain rice powder was prepared by combining a mixture of about 65 parts water and about 35 parts malted rice flour (Eckert Malting, Chico, Calif.). The mixture was processed at about 70° C. to allow endogenous enzymes to solubilize starches and proteins within the flour. A high shear mixer (Silverson LMA-5) was used to break down residual particles and mash the malt for an additional 60 minutes at about 70° C. The preparation was transferred by peristaltic pump through a flexible hose to the atomizing nozzle of a lab spray dryer (Toption Lab Dryer with a centrifugal atomizing nozzle, with an inlet temperature of about 140° C., and an outlet temperature of about 100° C.) and dried to create a readily soluble wholegrain germinated rice flour.

In an example, a measure of about 4 grams of rice bran wax obtained from Koster Kuenen was combined with about 46 grams of rice bran stearin and heated to a temperature of about 80° C. to create a melt. Next, about 10 grams of the readily soluble wholegrain rice flour powder was dispersed into the melt. An aliquot of the melt was dripped onto a steel tray and solidified into an oleogel prill approximately 2 to 10 mm in size. This semi-solid oleogel has the advantage of using ingredients that all derive from rice.

In another example, a measure of about 4 grams of rice bran wax obtained from Koster Kuenen was combined with about 46 grams of rice bran stearin and heated to a temperature of about 80° C. to create a melt. Next, about 10 grams of maltodextrin powder was dispersed into the melt. An aliquot of the melt was dripped onto a steel tray and solidified into an oleogel prill approximately 2 to 10 mm in size.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method to create an oleogel, the method comprising:
combining a gelator with an oil;
co-melting the gelator and the oil at a temperature to form a melt;
dispersing at least one inclusion in the melt to form a mixture; and
cooling the mixture to create a solidified oleogel.

2. The method of claim 1, wherein the gelator is selected from the group consisting of: a rice bran wax, a jojoba wax, a sunflower wax, a Rhus succedanea fruit wax, a berry fruit wax (Rhus verniciflua), a pongamia seed wax, and a grape seed wax.

3. The method of claim 1, wherein the oil is selected from the group consisting of: a rice bran oil, a fractionated rice bran oil, a sunflower oil, an olive oil, a grape seed oil, an avocado oil, an almond oil, and a soy oil.

4. The method of claim 1, wherein the temperature is between approximately 50° C. to approximately 120° C.

5. The method of claim 1, further comprising:
incorporating the solidified oleogel into a meat analogue mixture.

6. The method of claim 1, further comprising:
engaging the solidified oleogel in a particle formation process; and
incorporating the solidified oleogel into a meat analogue mixture.

7. The method of claim 6, wherein the particle formation process is selected from the group consisting of: prilling, extrusion granulation, and milling.

8. The method of claim 7, wherein particles are suspended in oil to create a pumpable oleogel prill-in-oil dispersion prior to incorporation into a meat analogue mixture.

9. The method of claim 1, wherein the gelator and the oil are from a same botanical source.

10. The method of claim 1, wherein the at least one inclusion is an immiscible flavor precursor.

11. The method of claim 10, wherein the immiscible flavor precursor is in a crystalline form, and wherein the immiscible flavor precursor is selected from the group consisting of: a vitamin, a mineral, a reducing sugar, a salt, and an amino acid.

12. The method of claim 10, wherein the vitamin is selected from the group consisting of: vitamin B1, niacin, vitamin B6, vitamin B2, and vitamin B12.

13. The method of claim 1, wherein the at least one inclusion is in a form of immiscible liquid droplets.

14. The method of claim 13, wherein the immiscible liquid droplets comprise an aqueous amino acid solution.

15. The method of claim 13, wherein the liquid droplets comprise a surfactant.

16. The method of claim 1, wherein the at least one inclusion is a natural flavor or a immiscible spray-dried flavor.

17. The method of claim 1, wherein the at least one inclusion is a readily soluble wholegrain flour or a flavor powder derived from a readily soluble wholegrain carrier.

18. The method of claim 1, wherein an oleogel system has a saturated fat level of less than 40% and a room temperature punch force at least one 200 grams.

19. The method of claim 1, wherein the at least one inclusion is micronized or emulsified to enhance an opacifying effect.

20. A plant-based burger comprising:
approximately 5% to approximately 40% of an oleogel as a visible fat replica.

21. An oleogel composition comprising:
approximately 1% to approximately 50% of one or more inclusions;
approximately 50% to approximately 99% of a non-hydrogenated vegetable oil; and
approximately 1% to approximately 20% of a gelator.

22. The oleogel composition of claim 21, wherein the one or more inclusions impart flavor or flavor precursors.

23. A system comprising:
a first oleogel composition having a first melting point; and
a second oleogel composition having a second melting point,
wherein each of the first oleogel composition and the second oleogel composition comprise:
one or more inclusions that impart flavor or flavor precursors;
a non-hydrogenated vegetable oil; and
a gelator, and
wherein the first melting point differs from the second melting point to release the flavor or the flavor precursors at differing time periods during cooking.

24. A method comprising:
mixing a rice bran wax with a rice bran oil to create a mixture;
heating the mixture to a temperature to create a melt;
combining the melt with crystalline glucose or crystalline thiamine hydrochloride; and
homogenizing the melt using a mixer.

25. The method of claim 24, further comprising:
dripping an aliquot of the melt onto the tray and solidifying the melt into oleogel-glucose dispersion prills or oleogel-thiamine dispersion prills.

26. The method of claim 25, wherein the oleogel-glucose dispersion prills and the oleogel-thiamine dispersion prills are more opaque and whiter than oleogel prills.

27. The method of claim 26, wherein the oleogel prills comprise a lower opacity compared to the oleogel-glucose dispersion prills and the oleogel-thiamine dispersion prills.

28. The method of claim 25, wherein a separation of the oleogel-glucose dispersion prills and the oleogel-thiamine dispersion prills and a reduction of sugar inclusions generates a Maillard flavoring upon melting.

29. A method to create an oleogel, the method comprising:
combining a gelator with an oil, wherein the gelator is a vegetable wax, and wherein the oil comprises a low saturated fat oil;
co-melting the gelator and the oil at a temperature to form a melt;
dispersing at least one immiscible inclusion in the melt to form a mixture; and
cooling the mixture to create a solidified oleogel.
